(19) United States
(12) Patent Application Publication
(10) Pub. No.: US 2025/0384282 A1
(43) Pub. Date: Dec. 18, 2025

(54) ADAPTIVE SELF-LEARNING METHOD AND ADAPTIVE SELF-LEARNING SYSTEM

(71) Applicant: ENEURAL TECHNOLOGIES, INC., Hsinchu County (TW)

(72) Inventors: Jiun-In GUO, Hsinchu City (TW); Wei-Lun CHEN, New Taipei City (TW)

(21) Appl. No.: 18/816,565

(22) Filed: Aug. 27, 2024

(30) Foreign Application Priority Data
Jun. 18, 2024 (TW) 113122507

(51) Int. Cl. G06N 3/0895; G06V 10/25; G06V 10/74; G06V 10/774

(52) U.S. Cl. CPC G06N 3/0895; G06V 10/25; G06V 10/761; G06V 10/7753

(57) ABSTRACT

The disclosure provides an adaptive self-learning method and an adaptive self-learning system. The adaptive self-learning method includes steps of inputting a first complex model and unlabeled data to an adaptive semi-supervised learning module and performing a pre-semi-supervised learning module to generate an average precision variation. If the average precision variation does not satisfy a condition value at any one time out of an inference count, the semi-supervised learning module is performed. After performing the semi-supervised learning module, the steps include performing a self-learning module for refining the target model, and then the trained target model is disposed to a site device. The site device deploys the trained target model to perform an object detection procedure.

### BACKGROUND OF THE DISCLOSURE

### Technical Field

The disclosure generally relates to a learning method and a learning system, particularly to an adaptive self-learning method and an adaptive self-learning system.

### Description of Related Art

The current semi-supervised learning framework adopts a teacher-student architecture, where the student model learns from the pseudo labels inferred by the teacher model. However, this operational mechanism has problems of limitations to the student model resulting from that the performance of the student model can only approach that of the teacher model and cannot surpass the teacher model, so the bottleneck of training the student model exists.

Moreover, in the existing framework, although the loss function can provide feedback to the training process of the student model, the loss function cannot evaluate the quality of the pseudo labels. All pseudo-labels generated by the teacher model are accepted during the training process, which increases the uncertainty in the training process of the student model and leads to another problem, that is, an increased probability of learning incorrect information. In other words, the current framework cannot resolve the training bias caused by the difference between labeled image data and unlabeled image data.

Furthermore, in the process of generating pseudo labels in the existing semi-supervised learning process, a fixed threshold is used for filtering data. Since all labels or object classifications cannot be evaluated by the same standard, the fixed threshold mechanism may result in generating too many pseudo labels or retaining incorrect pseudo labels.

On the other hand, edge devices or devices running on embedded systems are constrained by hardware conditions, such as computational power or storage capacity, making it impossible to perform comprehensive model training, and it results in restrictions to the implementation of artificial intelligence.

Accordingly, how to solve the restrictions to the implementation of artificial intelligence is an issue for the person skilled in the art.

### SUMMARY OF THE INVENTION

One embodiment of the disclosure provides an adaptive self-learning method performed by a computation device including (a) inputting a first complex model and an unlabeled image data to an adaptive semi-supervised learning module; (b) repeatedly performing a pre-semi-supervised learning module of the adaptive semi-supervised learning module to generate an average precision variation; (c) when the average precision variation does not satisfy a condition value at any one time out of an inference count, performing a semi-supervised learning module of the adaptive semi-supervised learning module, performing the semi-supervised learning module to send the first complex model to a teacher model, and using the teacher model to train a student model until a loss level between a teacher-inference result of the teacher model and a student-inference result of the student model is less than an error value, wherein the teacher model and the first complex model have similar neural network architecture; (d) selecting one model with a higher accuracy of the teacher-inference result and the student-inference result from the teacher model and the student model wherein loss levels of the teacher model and the student model are less than the error value, sending the one model to a second complex model of a self-learning module, providing a small model whose model architecture is similar to the teacher model or the student model as a target model, and performing the self-learning module to use the second complex model and the target model to refine the unlabeled image data to output an effective image data; (e) performing a supervised learning module on the target model by using the effective image data to train the target model; and (f) disposing, by the computation device, the target model trained to a site device to make the site device deploy the target model trained to perform an object-detecting procedure.

Another embodiment of the disclosure provides an adaptive self-learning system operated by a computation device. The adaptive self-learning system includes a first complex model, an adaptive semi-supervised learning module, and a self-learning module. The first complex model includes a neural network architecture. The adaptive semi-supervised learning module includes a teacher model, a student model, a pre-semi-supervised learning module, and a semi-supervised learning module. The teacher model receives the neural network architecture of the first complex model and unlabeled image data. The pre-semi-supervised learning module is configured to repeatedly perform a model inference of the teacher model and the student model and generate an average precision variation by comparing model inference results before and after the model inference. When the average precision variation does not satisfy a condition value at any one time out of an inference count, the semi-supervised learning module sends the first complex model to the teacher model and uses the teacher model to train the student model until a loss level between a teacher-inference result of the teacher model and a student-inference result of the student model is less than an error value. The self-learning module includes a second complex model and a target model. The self-learning module is configured to select one model with a higher accuracy of the teacher-inference result and the student-inference result from the teacher model and the student model, where the loss levels of the teacher model and the student model are less than the error value, send the one model to the second complex model, provide a small model whose model architecture is similar to the teacher model or the student model as the target model, use the second complex model and the target model to refine the unlabeled image data to output an effective image data, perform a supervised learning module on the target model by using the effective image data to train the target model, and dispose the target model trained to a site device by the computation device to make the site device deploy the target model trained to perform an object-detecting procedure.

### BRIEF DESCRIPTION OF THE DRAWINGS

FIG. 1 is a working flow of an adaptive self-learning system according to an embodiment of the present disclosure.

FIG. 2 is a working flow of an adaptive semi-supervised learning module according to an embodiment of the present disclosure.

FIG. 3 is a working flow of a self-learning module according to an embodiment of the present disclosure.

FIG. 4 is a block diagram of a computation device according to an embodiment of the present disclosure.

FIG. 5 is a flowchart of an adaptive self-learning method according to an embodiment of the present disclosure.

FIG. 6 is a flowchart of performing a semi-supervised learning module of the adaptive self-learning method according to an embodiment of the present disclosure.

FIG. 7 is a flowchart of performing a self-learning module of the adaptive self-learning method according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

For the sake of understanding the disclosure, some terms used in the disclosure are briefly defined below. The term “model” indicates an algorithm that has neural network architecture (such as an input layer, multiple hidden layers, and an output layer) and performs an inference process on the input data by an artificial neural network algorithm; the term “module” indicates a computation about using the model inference result or an algorithm related to data computation processing.

In the disclosure, algorithm computations of models and the modules may be performed by any chip having computation ability, such as a Graphics Processing Unit (GPU).

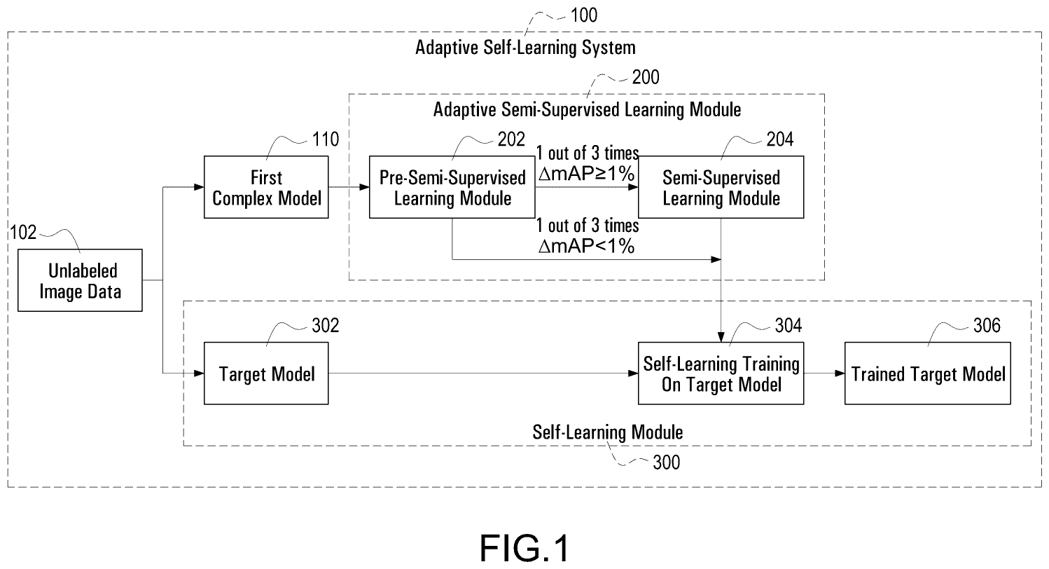

FIG. 1 is a working flow of an adaptive self-learning system according to an embodiment of the present disclosure.

An adaptive self-learning system 100 may be performed by a computation device (not shown in figures) having a good computation ability. The computation device performs an adaptive semi-supervised learning process and incorporates self-learning to improve the learning efficiency of the student model and enhance the stability of a learning process that may be converged based on the knowledge distillation, so the training process may be finished fast. The student model that has been trained is suitable to be deployed on devices with lower computation power or hardware costs, such as edge devices, where the memory space is smaller compared to the computation device. Therefore, even if the edge devices have lower computation power or hardware costs compared to the computation device, the technology of the disclosure allows for the rapid deployment of the trained model to perform an object-detecting procedure (hereby reducing the preparation time required for training).

The adaptive self-learning system 100 includes a first complex model 110, an adaptive semi-supervised learning module 200, and a self-learning module 300.

The first complex model 110 includes a neural network architecture. In one embodiment, the first complex model 110 is a neural network model that is pre-trained. The pre-trained neural network model is the model that has been trained by a large quantity of general data and a small quantity of labeled image data and may perform general inference processes, such as inferring pseudo labels of unlabeled image data (the accuracy is relatively poor).

The adaptive semi-supervised learning module 200 includes a pre-semi-supervised learning module 202 and a semi-supervised learning module 204.

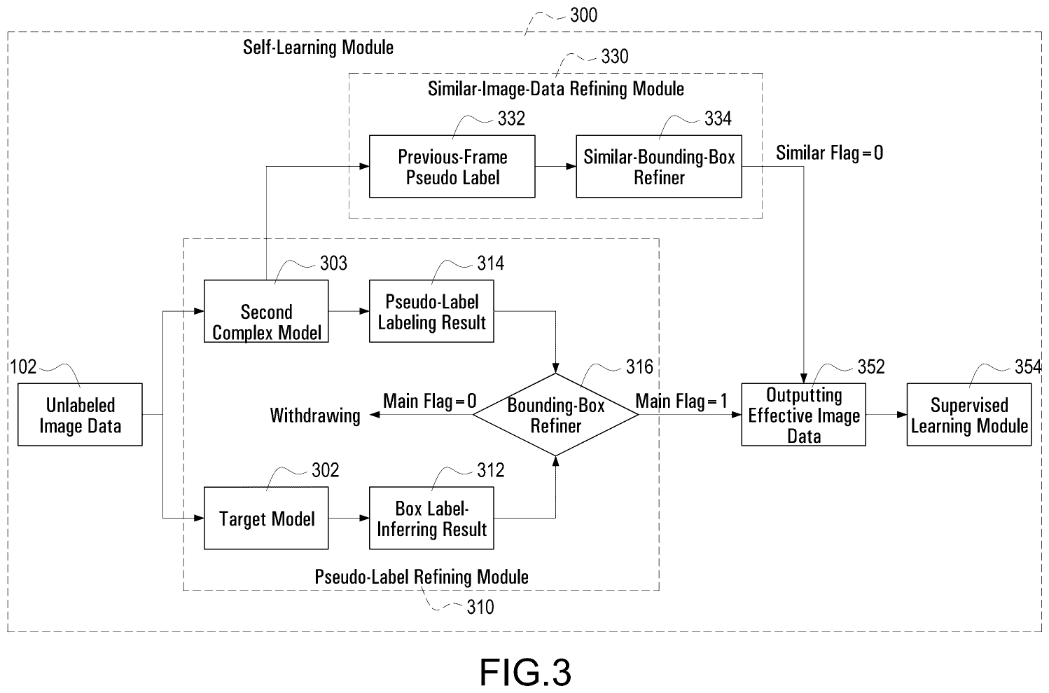

The self-learning module 300 includes a target model 302. In one embodiment, the target model 302 is a simple model whose number of neurons and hidden layers of a neural network architecture is less than the first complex model 110 or a second complex model 303 (in FIG. 3).

In the initial state, the adaptive self-learning system 100 receives unlabeled image data 102. The unlabeled image data 102 is a data cluster without being labeled manually, such as image frames continuously in time.

The adaptive self-learning system 100 inputs the unlabeled image data 102 respectively to the first complex model 110 and the target model 302 of the self-learning module 300.

The adaptive self-learning system 100 inputs the unlabeled image data 102 to the working flow of the first complex model 110, and the first complex model 110 and the unlabeled image data 102 are sent to the adaptive semi-supervised learning module 200.

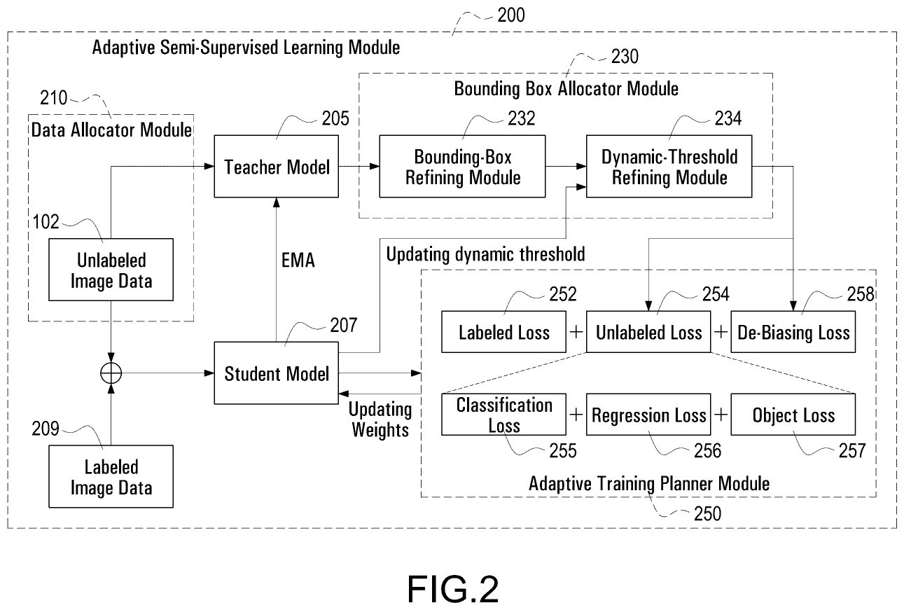

In one embodiment, the unlabeled image data 102 includes pseudo-label image data generated by inferring the unlabeled image data 102 by the first complex model 110 and the pseudo-label image data (a detailed description is provided in FIG. 2) refined by the dynamic-threshold refining module 234.

In the initial state, the first complex model 110 infers on the unlabeled image data 102 and generates an inference result as the pseudo-label image data (not shown in FIG. 1), and the pseudo-label image data of the inference result is provided to a data allocator module 210 to perform data augmentation (a detailed description is provided in FIG. 2).

The adaptive semi-supervised learning module 200 includes the pre-semi-supervised learning module 202 and the semi-supervised learning module 204.

In the initial state that the adaptive semi-supervised learning module 200 receives the first complex model 110 and the unlabeled image data 102, the pre-semi-supervised learning module 202 is performed repeatedly. In the working flow, the pre-semi-supervised learning module 202 computes an average precision variation (AmAP) of each time based on the inference result of the teacher model and the student model (a detailed description is provided later). The average precision variation is used to estimate the accuracy of the inference result made by the student model.

In the working flow of the adaptive semi-supervised learning module 200, if the pre-semi-supervised learning module 202 determines that a count of the average precision variation does not satisfy a condition value (such as <1%) at any one time out of an inference count (such as three times), it represents that the accuracy of the first complex model 110 being pre-trained does not meet the requirement, so the semi-supervised learning module 204 is performed for further training. Otherwise, if the pre-semi-supervised learning module 202 determines that the count of the average precision variation satisfies the condition value reaches the inference count, it represents that the accuracy of the first complex model 110 meets the requirement and no more training is required, so the working flow after finishing the pre-semi-supervised learning module 202 skips the semi-supervised learning module 204 and goes to a self-learning training 304 on the target-model 302.

The semi-supervised learning module 204 uses the teacher-student architecture to perform the knowledge distillation (a detailed description is provided later). The student model after finishing the knowledge distillation is provided as the target model 302 of the self-learning module 300, and then the self-learning module 300 continuously performs the self-learning training on the target model 302 to obtain a trained target model 306 (or called “target model trained”). For example, when the average precision variation of the pre-semi-supervised learning module 202 is not less than 1% one time out of three times, it represents that the student model has the improvement possibility and there is a need for further optimizing the training of the student model by using the teacher model during performing the semi-supervised learning module 204, and the working flow stays instead of going to the self-learning module 300. Otherwise, when the average precision variation of the pre-semi-supervised learning module 202 is less than 1% for continuous three times, it represents that the improvement rate (variation) of the student model is low, and there is no need to perform the optimization training on the student model by using the teacher model. In other words, the student model almost equips the knowledge of the teacher model, so the working flow goes to the self-learning module 300.

In one embodiment, the first complex model 110 and the target model 302 are models having similar neural network architecture. The difference is that the number of neurons and hidden layers of the first complex model 110 is greater than the target model 302; compared to the first complex model 110, the target model 302 is more suitable for edge devices with lower computation power or hardware costs. For example, the first complex model 110 is the latest official version of the YOLO object detection model (such as YOLO v7 in 2022), and the target model 302 is a compression and pruning framework of the old version of the YOLO object detection model (such as YOLO v4 in 2020).

FIG. 2 is a working flow of an adaptive semi-supervised learning module according to an embodiment of the present disclosure.

The adaptive semi-supervised learning module 200 includes a teacher model 205, a student model 207, the data allocator module 210, a bounding box allocator module 230, and an adaptive training planner module 250.

In one embodiment, the adaptive self-learning system 100 performs a model transfer, taking the first complex model 110 as the preliminary content of the teacher model 205 and the student model 207 at the same time. In the following working flow, taking the teacher model 205 and the student model 207 as the bases, the knowledge distillation of the teacher model 205 and the student model 207 is performed by using the unlabeled image data 102 and labeled image data 209.

In the embodiment that the average precision variation of the pre-semi-supervised learning module 202 does not satisfy the condition value (such as <1%) at any one time out of the inference count (such as three times), the data allocator module 210 performs a weak-data augmentation process on the unlabeled image data 102 to generate unlabeled weakly-augmented data (not shown in figures) and sends the unlabeled weakly-augmented data to the teacher model 205.

The weak-data augmentation process, for example, involves performing simple angle transformations on the unlabeled image data 102 to obtain multiple similar unlabeled image data. In the embodiment, the unlabeled image data 102 inputted to the teacher model 205 includes the unlabeled image data processed by the weak-data augmentation process.

In the working flow of the teacher model 205, the teacher model 205 uses the unlabeled weakly-augmented data as the input data to perform the model inference. The teacher model 205 generates teacher-inference results related to the unlabeled image data 102. For example, the inference results include the probability values of all pseudo labels (or called “classification”) corresponding to each bounding box in the unlabeled image data 102 or the probability values of all pseudo labels corresponding to the unlabeled image data 102 generated by the teacher model 205 after the teacher model 205 computes the probability values of the pseudo labels of all bounding boxes. The teacher model 205 then sends the teacher-inference results to the bounding box allocator module 230.

The bounding box allocator module 230 includes a bounding-box refining module 232 and the dynamic-threshold refining module 234. In one embodiment, the bounding box allocator module 230 pre-sets the bounding boxes and dynamic thresholds of the labels as the basis of obtaining the bounding boxes and the pseudo labels by refining the teacher model 205.

The bounding-box refining module 232 receives the teacher-inference results of the teacher model 205 and refines the pseudo label of an inference error of the teacher model 205, that is, filtering out the bounding box that the confidence threshold of the teacher-inference result is less than the dynamic threshold (not satisfying the correct answer). The bounding-box refining module 232 sends a bounding-box refining result to the dynamic-threshold refining module 234. The bounding-box refining module 232 may refine the incorrect bounding box and improve the inference result of the teacher model 205.

The dynamic-threshold refining module 234 pre-sets the dynamic threshold of each label corresponding to each bounding box. The dynamic-threshold refining module 234 computes probabilities of all pseudo labels corresponding to each bounding box of the bounding-box refining results and filters out the unsatisfied pseudo label of each bounding box according to the dynamic threshold of each pre-set label.

In one embodiment, the dynamic-threshold refining module 234 may filter out the unsuitable pseudo label and obtain the pseudo-label image data (not shown in FIG. 2) that is suitable for training. Then, the pseudo-label image data is taken as one part of the unlabeled image data 102. The data incorporating the unlabeled image data 102 including the pseudo-label image data with the labeled image data 209 is sent to the student model 207 for inferencing. The teacher model 205 is improved and outputs more accurate inference results, to avoid a worse inference result influencing the student model 207 toward an incorrect inference. The dynamic-threshold refining module 234 sends the refined image data whose bounding boxes and labels are refined to the adaptive training planner module 250.

On the other hand, the data allocator module 210 performs a strong-data augmentation process on the unlabeled image data 102 to generate unlabeled strongly-augmented data (not shown in figures). In one embodiment, at the first allocation process, the data allocator module 210 uses the first complex model 110 having the initial state to perform the inference on the unlabeled image data 102 to generate the inference result, and the inference result is taken as the pseudo-label image data. The pseudo-label image data is taken as one part of the unlabeled image data 102, and the data allocator module 210 performs the strong-data augmentation process on the pseudo-label image data and the unlabeled image data 102.

The strong-data augmentation process is, for example, performing complex angle transformations, flips, translations, or scaling on the unlabeled image data 102 to generate multiple similar unlabeled image data. Compared to the weak-data augmentation process, the strong-data augmentation process performs a greater level of data augmentation on the unlabeled image data 102. That is, the strong-data augmentation process generates more different augmented data than the original unlabeled image data 102, so the image diversity is enhanced.

In the working flow of the student model 207, the student model 207 takes the unlabeled strongly-augmented data, the labeled image data 209, the unlabeled image data 102, and the pseudo-label image data as the input data to perform the model inference. The inference result includes the probabilities of all labels (or called “classification”) corresponding to each bounding box of the unlabeled image data 102, or the probabilities of all labels of the unlabeled image data 102 after the student model 207 computes the probability of the labels of all bounding boxes.

It should be noted that the teacher model 205 performs an inference process on the unlabeled image data 102, and the classification of the teacher-inference result is called “pseudo label”. On the other hand, the student model 207 performs the inference process based on the labeled image data 209 and the pseudo-label image data that are refined by the dynamic-threshold refining module 234. In the disclosure, the classification of the student-inference result is called “label”.

The adaptive training planner module 250 receives the refined image data of the dynamic-threshold refining module 234 and the student-inference result of the student model 207. The adaptive training planner module 250 computes a labeled loss 252, an unlabeled loss 254, and a de-biasing loss 258 to obtain a loss level between the inference results of the teacher model 205 and the student model 207. In one embodiment, the unlabeled loss 254 is the sum of a classification loss 255, a regression loss 256, and an object loss 257.

In one embodiment, the adaptive training planner module 250 updates weights of the student model 207 according to the loss level. Specifically, the student model 207 takes the neural network architecture of the first complex model 110 as a basis and has multiple parameters, where the parameters are the weights, in one embodiment. By updating the weights of the student model 207, the adaptive training planner module 250 may directly converge the inference results of the student model 207 and indirectly converge the inference results of the teacher model 205.

It should be noted that the weights of the teacher model 205 may not be directly updated by the adaptive training planner module 250. In one embodiment, the adaptive semi-supervised learning module 200 performs an exponential moving average (EMA) process and uses the weights of the student model 207 to slightly adjust the weights of the teacher model 205 to improve the accuracy of the teacher-inference result (such as the probability of the pseudo label) outputted by the teacher model 205 in the next epoch. Therefore, it can prevent the teacher model 205 from drastic iterative updates, which may lead to a negative influence on the training results.

In one embodiment, the adaptive semi-supervised learning module 200 determines that the inference results of the student model 207 and the teacher model 205 are similar, indicating that the student model 207 is trained and similar to the teacher model 205. Then, the working flow goes to the self-learning module 300 from the adaptive semi-supervised learning module 200.

FIG. 3 is a working flow of a self-learning module according to an embodiment of the present disclosure.

The self-learning module 300 includes a pseudo-label refining module 310 and a similar-image-data refining module 330. The pseudo-label refining module 310 includes a second complex model 303, a target model 302, and a bounding-box refiner 316.

Following the embodiment provided in FIG. 2, the student model 207 is trained to be similar to the teacher model 205. In one embodiment, the adaptive self-learning system 100 selects one model from the teacher model 205 and the student model 207, and the better model is selected and sent to the second complex model 303. Furthermore, a small model whose neural network architecture is similar to the teacher model 205 or the student model 207 and that is more suitable to be deployed on the edge devices having lower computation power or hardware costs is provided as the target model 302. For example, the adaptive self-learning system 100 selects one model with higher accuracy of the teacher-inference result and the student-inference result from the teacher model 205 and the student model 207 as the second complex model 303. It should be noted that selecting a similar model architecture by the adaptive self-learning system 100 indicates that the model is also a kind of the YOLO object detection model, and the small model has a number of neurons and hidden layers that are less than the number that the teacher model 205 and the student model 207 have.

The self-learning module 300 inputs the unlabeled image data 102 respectively to the second complex model 303 and the target model 302 of the pseudo-label refining module 310. To simplify the description of operations of the self-learning module 300, the unlabeled image data of a current frame is regarded as the unlabeled image data 102, such as the current frame of real-time image frames.

The second complex model 303 performs the model inference on the unlabeled image data of the current frame and generates a pseudo-label labeling result 314. Meanwhile, the target model 302 performs the model inference and outputs a bounding-box label-inferring result 312 of the unlabeled image data of the current frame.

The bounding-box refiner 316 compares the pseudo-label labeling result 314 with the bounding-box label-inferring result 312 and obtains a bounding-box similarity. In one embodiment, the pseudo-label labeling result 314 and the bounding-box label-inferring result 312 respectively include the multiple bounding boxes and the pseudo labels/labels obtained from the model inference. The bounding-box refiner 316 computes an intersection over union (IoU) (such as the value that the overlapped area of two bounding boxes divided by the union area of two bounding boxes) of the bounding boxes on the nearby image positions of the pseudo-label labeling result 314 and the bounding-box label-inferring result 312. If the IoU is high, it represents that the inference result of the second complex model 303 is similar to the inference result of the target model 302 (Main Flag=1), and the bounding-box refiner 316 keeps the unlabeled image data of the current frame; otherwise (Main Flag=0), the bounding-box refiner 316 withdraws the unlabeled image data of the current frame.

On the other hand, the second complex model 303 sends the bounding boxes of the unlabeled image data of the current frame to a similar-bounding-box refiner 334 of the similar-image-data refining module 330.

The similar-bounding-box refiner 334 compares the bounding box of the unlabeled image data of the current frame with the bounding box of the image data of a previous frame (or called “previous-frame pseudo label” 332) to obtain a frame similarity of two adjacent frames. In one embodiment, the similar-bounding-box refiner 334 compares all the bounding boxes of the current frame with all the bounding boxes of the previous frame. If a bounding-box similarity of the two frames is greater than an object-similarity threshold (such as 80%), it represents that the two frames are highly similar and the similar-bounding-box refiner 334 withdraws the unlabeled image data of the current frame to prevent the waste of the computation costs. If the bounding-box similarity of the two frames is less than or equal to the object-similarity threshold, it represents that the frame similarity of the two frames is low (Similar Flag=0) and the similar-bounding-box refiner 334 keeps the unlabeled image data of the current frame.

Then, when receiving signals indicating that the inference results are similar (Main Flag=1) and the frame similarity of the two frames is low (Similar Flag=0), the self-learning module 300 outputs the unlabeled image data of the current frame as an effective image data 352.

A supervised learning module 354 uses the effective image data 352 to continuously perform the self-learning training 304 on the target model 302 until the supervised learning module 354 obtains the trained target model 306.

The trained target model 306 may be regarded as the artificial intelligence model that is well-trained and suitable for some specific fields/sites. Then, the computation device may dispose the trained target model 306 to a site device to make the site device deploy the trained target model 306 to perform the object-detecting procedure.

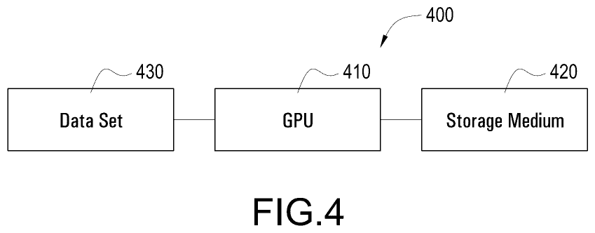

FIG. 4 is a block diagram of a computation device according to an embodiment of the present disclosure.

The computation device 400 includes a graphics processing unit (GPU) 410, a storage medium 420, and a data set 430. The storage medium 420 is connected to the GPU 410 and configured to store multiple program codes. The data set 430 includes the unlabeled image data 102 and the labeled image data 209. The GPU 410 may receive the data set 430 through the Internet, a bus, or the like. When the GPU 410 loads the multiple program codes, operations of the working flows of the adaptive self-learning system are performed.

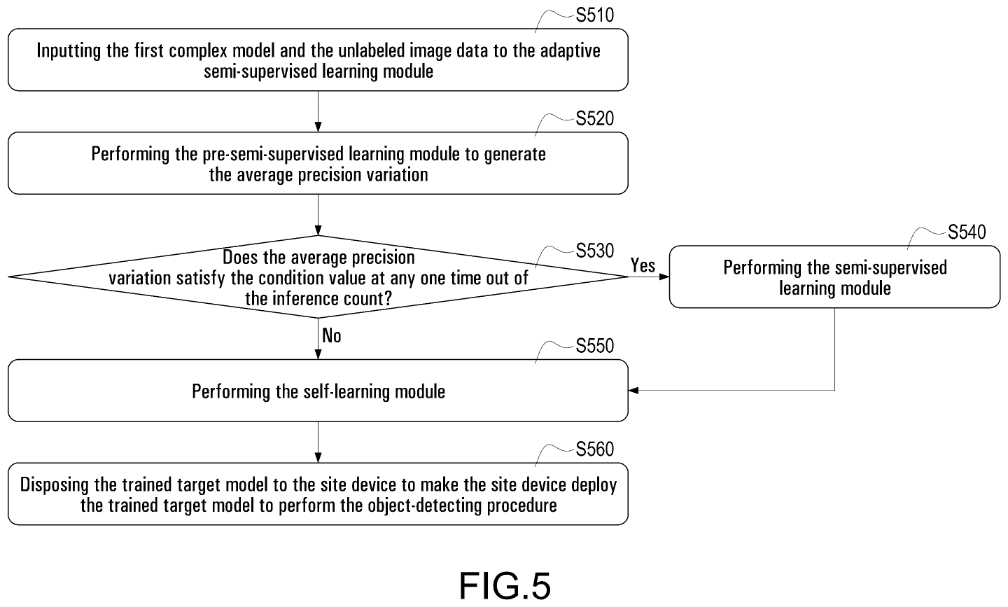

FIG. 5 is a flowchart of an adaptive self-learning method according to an embodiment of the present disclosure. The adaptive self-learning method may be performed by the computation device 400 if FIG. 4.

In step S510, inputting the first complex model 110 and the unlabeled image data 102 to the adaptive semi-supervised learning module 200 is performed.

In step S520, performing the pre-semi-supervised learning module 202 to generate the average precision variation ΔmAP is performed.

In step S530, determining whether the average precision variation ΔmAP does not satisfy the condition value (such as <1%) at any one time out of the inference count (such as 3 times) is performed. For example, if the average precision variation ΔmAP is greater than or equal to 1% one time out of consecutive three times (i.e., does not satisfy the condition value), the process goes to step S540 to perform the semi-supervised learning module 204. If the average precision variation ΔmAP is less than 1% for consecutive three times (i.e., satisfy the condition value), the process goes to step S550 to perform the self-learning module 300. In step S540, after the semi-supervised learning module 204 is performed and the teacher model finishes training on the student model, the process goes to step S550 of using the student model 207 as the target model 302 to proceed the self-training process of the target model 302 until the target model 306 is trained.

In step S560, the computation device 400 disposes the trained target model 306 to the site device to make the site device deploy the trained target model 306 to perform the object-detecting procedure.

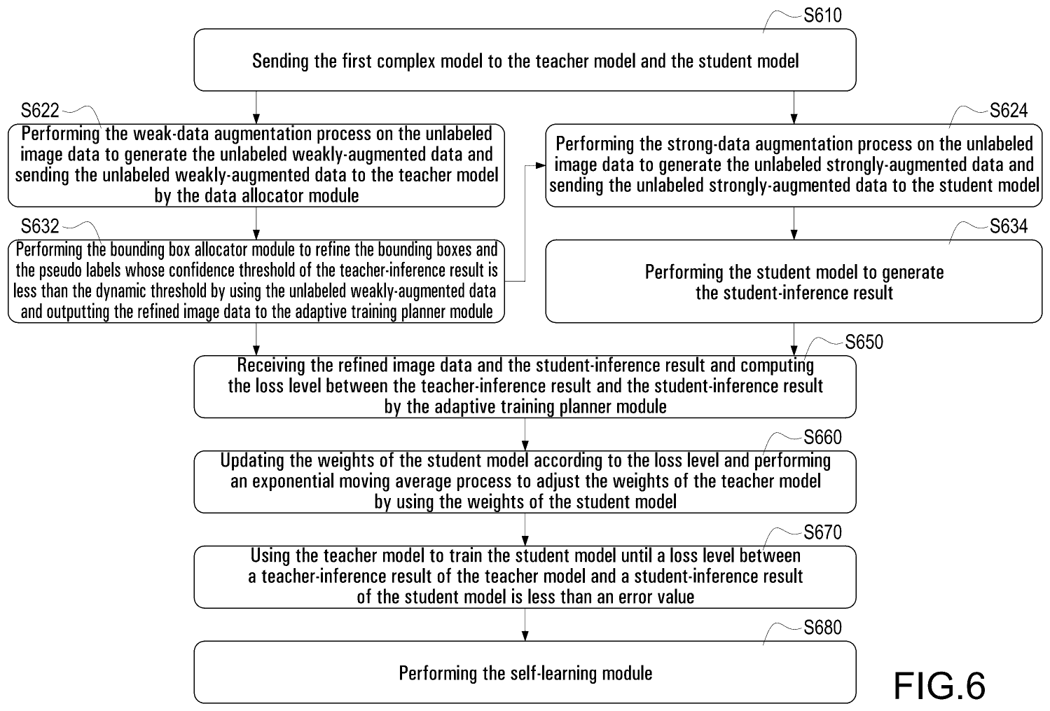

FIG. 6 is a flowchart of performing a semi-supervised learning module of the adaptive self-learning method according to an embodiment of the present disclosure.

In step S610, the adaptive semi-supervised learning module 200 sends the first complex model 110 to the teacher model 205 and the student model 207.

In step S622, performing the weak-data augmentation process on the unlabeled image data 102 to generate the unlabeled weakly-augmented data and sends the unlabeled weakly-augmented data to the teacher model 205 by the data allocator module 210 is performed.

In step S632, performing the bounding box allocator module 230 to refine the bounding boxes and the pseudo labels whose confidence threshold of the teacher-inference result is less than the dynamic threshold by using the unlabeled weakly-augmented data and outputting the refined image data to the adaptive training planner module 250 is performed.

On the other hand, in step S624, performing the strong-data augmentation process on the unlabeled image data 102 to generate the unlabeled strongly-augmented data and sending the unlabeled strongly-augmented data to the student model 207 by the data allocator module 210 is performed.

In one embodiment, the refined image data (i.e., the pseudo-label image data) outputted in step S632 are also regarded as one part of the unlabeled image data 102, and the data allocator module 210 performs the strong-data augmentation process on the unlabeled image data 102, the pseudo-label image data, and the labeled image data 209 in step S624.

In step S634, performing the student model 207 to generate the student-inference result is performed.

In step S650, receiving the refined image data and the student-inference result and computing the loss level between the teacher-inference result and the student-inference result by the adaptive training planner module 250 is performed.

In step S660, updating the weights of the student model 207 according to the loss level and performing an exponential moving average process to adjust the weights of the teacher model 205 by using the weights of the student model is performed. In one embodiment, the loss level includes a labeled loss 252, an unlabeled loss 254, and a de-biasing loss 258, where the unlabeled loss 254 is the sum of a classification loss 255, a regression loss 256, and an object loss 257. In the disclosure, the adaptive training planner module 250 respectively updates the weights of parameters of the student model 207 based on the values of the multiple losses and the parameter importance.

In step S670, using the teacher model 205 to train the student model 207 until a loss level between a teacher-inference result of the teacher model 205 and a student-inference result of the student model 207 is less than an error value is performed.

In step S680, using the teacher model 205 refined and the student model 207 trained to perform the self-learning module 300 is performed.

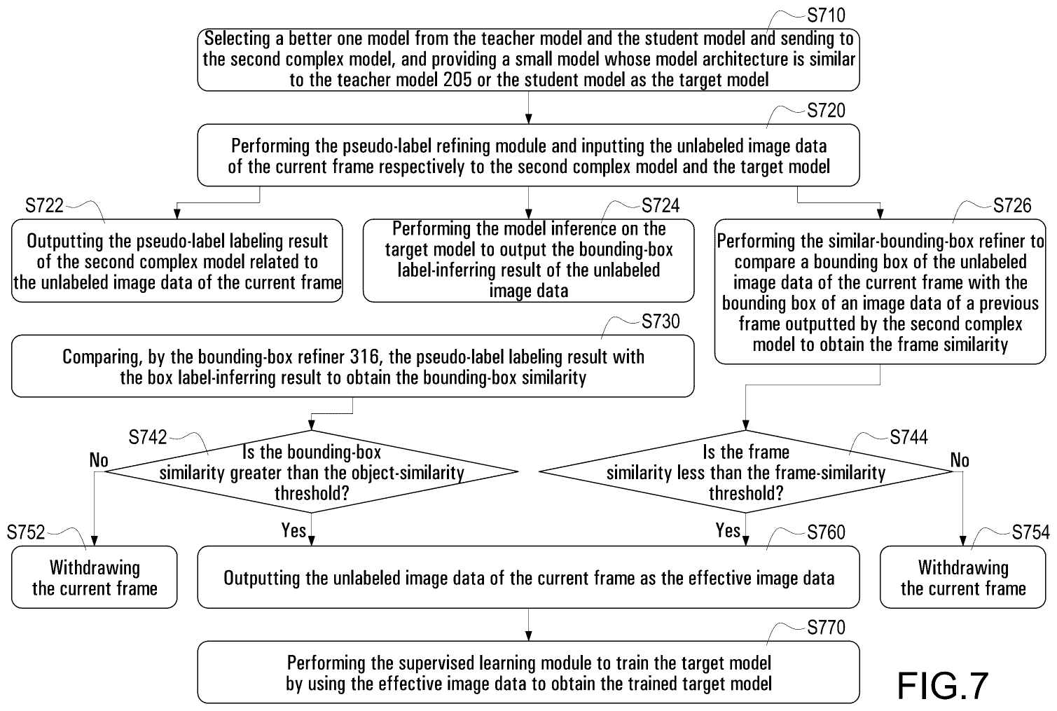

FIG. 7 is a flowchart of performing a self-learning module of the adaptive self-learning method according to an embodiment of the present disclosure.

In step S710, selecting a better one model from the teacher model 205 and the student model 207, sending the better one model to the second complex model 303, and providing a small model whose model architecture is similar to the teacher model 205 or the student model 207 as the target model that is more suitable to be deployed on the edge devices having lower computation power or hardware costs is performed.

In one embodiment, said selecting the better one model indicates selecting the model having the most accurate model output result.

In step S720, performing the pseudo-label refining module 310 and inputting the unlabeled image data 102 of the current frame respectively to the second complex model 303 and the target model 302 is performed.

In step S722, outputting the pseudo-label labeling result of the second complex model 303 related to the unlabeled image data 102 of the current frame is performed.

In step S724, performing the model inference on the target model 302 to output the bounding-box label-inferring result 312 of the unlabeled image data is performed.

In step S730, comparing, by the bounding-box refiner 316, the pseudo-label labeling result 314 with the box label-inferring result 312 to obtain a bounding-box similarity is performed.

In step S742, determining whether the bounding-box similarity is greater than the object-similarity threshold is performed. If the bounding-box similarity is greater than the object-similarity threshold, the process goes to step S760; otherwise, the process goes to step S752 of withdrawing the current frame.

On the other hand, in step S726, performing the similar-bounding-box refiner 334 to compare a bounding box of the unlabeled image data 102 of the current frame with the bounding box of an image data of a previous frame outputted by the second complex model 303 to obtain the frame similarity is performed.

In step S744, determining whether the frame similarity is less than the frame-similarity threshold is performed. If the frame similarity is less than the frame-similarity threshold, the process goes to step S760; otherwise, the process goes to step S754 of withdrawing the current frame.

In step S760, outputting the unlabeled image data 102 of the current frame as the effective image data 352 is performed.

In step S770, performing the supervised learning module 354 to train the target model by using the effective image data 352 to obtain the trained target model 306 is performed.

Then, the computation device 400 disposes the trained target model 306 to the site device to make the site device deploy the trained target model 306 to perform the object-detecting procedure.

The disclosure providing the adaptive self-learning system, the adaptive self-learning method, and the computation device respectively apply the pre-semi-supervised learning module 202 and the semi-supervised learning module 204 to make the preliminary decision of whether the first complex model 110 having a certain inference ability is suitable for applying at the unlabeled image data 102 of a specific site or field. In a situation where the first complex model 110 is suitable for applying at the specific site or field, the adaptive self-learning system 100 may directly skip to the self-learning module 300 to perform the self-learning process. In a situation where the first complex model 110 having a certain inference ability is not suitable for applying at the specific site or field, the adaptive self-learning system 100 performs the adaptive semi-supervised learning module 200 to train the student model 207 based on the teacher-student architecture.

Furthermore, the bounding box allocator module 230 filters out the unsuitable or error teacher-inference result and immediately refines the teacher model 205 during the training process, so the accuracy that the teacher model 205 trains the student model 207 is improved. In addition, the adaptive training planner module 250 sends feedback to update the weights of the student model 207 and immediately adjusts the weights of the teacher model 205 slightly by the exponential moving average process, so the process of tuning the weights of the teacher model 205 may be performed without waiting for the end of the entire training process and the flexibility of training models is enhanced.

Furthermore, the self-learning module 300 may determine the image frames that are similar to each other and compute the inference results of the second complex model 303 and the target model 302 to output the effective image data that are necessary to decrease redundant or unnecessary training computation.

Accordingly, the disclosure technique may obtain the target models that are suitable for deploying at different fields or sites by fast training in the condition of saving computation resources, so the application scopes of the artificial intelligence are extended.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An adaptive self-learning method performed by a computation device comprising:
(a) inputting a first complex model and an unlabeled image data to an adaptive semi-supervised learning module;
(b) repeatedly performing a pre-semi-supervised learning module of the adaptive semi-supervised learning module to generate an average precision variation;
(c) when the average precision variation does not satisfy a condition value at any one time out of an inference count, performing a semi-supervised learning module of the adaptive semi-supervised learning module, performing the semi-supervised learning module to send the first complex model to a teacher model, and using the teacher model to train a student model until a loss level between a teacher-inference result of the teacher model and a student-inference result of the student model is less than an error value, wherein the teacher model and the first complex model have similar neural network architecture;
(d) selecting one model with a higher accuracy of the teacher-inference result and the student-inference result from the teacher model and the student model wherein loss levels of the teacher model and the student model are less than the error value, sending the one model to a second complex model of a self-learning module, providing a small model whose model architecture is similar to the teacher model or the student model as a target model, and performing the self-learning module to use the second complex model and the target model to refine the unlabeled image data to output an effective image data;
(e) performing a supervised learning module on the target model by using the effective image data to train the target model; and
(f) disposing, by the computation device, the target model trained to a site device to make the site device deploy the target model trained to perform an object-detecting procedure.

2. The adaptive self-learning method of claim 1, wherein step (c) further comprises:
(c1) performing a weak-data augmentation process on the unlabeled image data by a data allocator module of the adaptive semi-supervised learning module to generate an unlabeled weakly-augmented data and sending the unlabeled weakly-augmented data to the teacher model.

3. The adaptive self-learning method of claim 2, wherein step (c) further comprises:
(c2) performing a strong-data augmentation process to the unlabeled image data by the data allocator module to generate an unlabeled strongly-augmented data and sending the unlabeled strongly-augmented data to the student model, wherein the student model and the teacher model have the similar neural network architecture.

4. The adaptive self-learning method of claim 3, wherein a step after step (c2) comprises:
(c3) performing a bounding box allocator module of the adaptive semi-supervised learning module to refine a pseudo label and a bounding box whose confidence threshold of a teacher-inference result of the teacher model is less than a dynamic threshold by using the unlabeled weakly-augmented data and outputting a refined image data; and
(c4) performing an adaptive training planner module of the adaptive semi-supervised learning module to receive the student-inference result and the refined image data and computing the loss level between the teacher-inference result and the student-inference result.

5. The adaptive self-learning method of claim 4, wherein a step after step (c4):
(c5) performing the adaptive training planner module to compute a labeled loss, an unlabeled loss, and a de-biasing loss to obtain the loss level and updating weights of the student model according to the loss level, wherein the unlabeled loss is a sum of a classification loss, a regression loss, and an object loss; and
(c6) performing an exponential moving average process to adjust the weights of the teacher model by using the weights of the student model.

6. The adaptive self-learning method of claim 5, wherein step (d) further comprises:
(d1) performing a pseudo-label refining module of the self-learning module to input the unlabeled image data of a current frame respectively to the second complex model and the target model;
(d2) outputting, by the second complex model, a pseudo-label labeling result of the second complex model related to the unlabeled image data of the current frame;
(d3) performing a model inference on the target model to output a bounding-box label-inferring result of the unlabeled image data of the current frame; and
(d4) comparing, by a bounding-box refining module, the pseudo-label labeling result with the bounding-box label-inferring result to obtain a bounding-box similarity.

7. The adaptive self-learning method of claim 6, wherein step (d) further comprises:
(d5) performing a similar-image-data refining module of the self-learning module to compare, by a similar-bounding-box refiner of the similar-image-data refining module, a bounding box of the unlabeled image data of a current frame with the bounding box of an image data of a previous frame outputted by the second complex model to obtain a frame similarity.

8. The adaptive self-learning method of claim 7, wherein step (d) further comprises:
(d7) when determining that the bounding-box similarity is greater than an object-similarity threshold in step (d4) and determining that the frame similarity is less than a frame-similarity threshold in step (d5), outputting the unlabeled image data of the current frame as the effective image data.

9. The adaptive self-learning method of claim 1, wherein a step after step (b) comprises:
(b1) when determining that a count of the average precision variation satisfying the condition value reaches the inference count, performing a self-learning module and skipping step (c) to perform step (d).

10. An adaptive self-learning system operated by a computation device, comprising:
a first complex model, comprising a neural network architecture;
an adaptive semi-supervised learning module, comprising:
a teacher model, configured to receive the neural network architecture of the first complex model and an unlabeled image data;
a student model;
a pre-semi-supervised learning module, configured to repeatedly perform a model inference of the teacher model and the student model and generate an average precision variation by comparing model inference results before and after the model inference; and
a semi-supervised learning module, configured to send the first complex model to the teacher model when the average precision variation does not satisfy a condition value at any one time out of an inference count, and use the teacher model to train the student model until a loss level between a teacher-inference result of the teacher model and a student-inference result of the student model is less than an error value; and
a self-learning module, comprising a second complex model and a target model, wherein the self-learning module is configured to select one model with a higher accuracy of the teacher-inference result and the student-inference result from the teacher model and the student model wherein loss levels of the teacher model and the student model are less than the error value and send the one model to the second complex model, provide a small model whose model architecture is similar to the teacher model or the student model as the target model, use the second complex model and the target model to refine the unlabeled image data to output an effective image data, perform a supervised learning module on the target model by using the effective image data to train the target model, and dispose the target model trained to a site device by the computation device to make the site device deploy the target model trained to perform an object-detecting procedure.
